(19) United States
(12) Patent Application Publication
(10) Pub. No.: US 2014/0207656 A1
(43) Pub. Date: Jul. 24, 2014

(54) DISPOSABLE PAYMENT ACCOUNT

(71) Applicant: Metavante Corporation, Jacksonville, FL (US)

(72) Inventor: Frank D'ANGELO, Mequon, WI (US)

(73) Assignee: Metavante Corporation, Jacksonville, FL (US)

(21) Appl. No.: 14/247,450

(22) Filed: Apr. 8, 2014

Related U.S. Application Data
(63) Continuation of application No. 11/331,844, filed on Jan. 13, 2006.

(51) Int. Cl. G06Q 40/02

(52) U.S. Cl. CPC G06Q 40/025
USPC 705/38

(57) ABSTRACT

Methods are provided of processing a transaction between a consumer and a merchant with a disposable financial account. The disposable financial account is created automatically at a financial institution upon receipt of information provided by the consumer requesting creation of the account through an interface with the financial institution. The consumer is provided with information identifying the disposable financial account through the interface. An authorization request for the transaction is received from the merchant over a financial processing network. The authorization request includes the information identifying the disposable financial account and a transaction amount. An approval for the authorization request is returned to the merchant over the financial processing network based on financial parameters of the disposable financial account. Funds are transferred from the disposable financial account corresponding to the transaction amount to control of the merchant. The disposable financial account is automatically closed after satisfaction of a predetermined condition.

### BACKGROUND OF THE INVENTION

This application relates generally to financial transactions. More specifically, this application relates to methods and systems for implementing a disposable financial account.

It is widely known that the paradigm governing consumer transactions has been evolving in recent years. This has been driven by consistent pressure applied by consumers for increased convenience and simplicity in identifying goods and/or services for purchase and effecting transactions for their purchase. Merchants have responded to this pressure in a number of different ways, the most conspicuous of which has been through the use of the Internet for selling goods and services. The Internet provides a venue by which consumers may review merchandise in the convenience of their homes or offices, find more precisely the products they wish to purchase, and arrange for convenient delivery of those products to their homes or offices. Other similar mechanisms for selling goods and services include catalog-based sales where consumers may make telephone orders for products offered for sale in catalogs, as well as “home shopping” television sales in which consumers initiate telephone orders for products described in television programming.

While these various offerings have greatly increased the convenience by which consumers may shop for goods and services, there has at the same time been a heightened concern among consumers about the dangers of identity theft. Such crimes are often the result of financial information being intercepted by a thief, who then misuses the financial information fraudulently. In the case of sales of goods and/or services, such financial information is often in the form of a credit-card number, a checking-account number, or the like. It has been widely reported that the sophistication by which thieves intercept information is constantly increasing, and it is similarly well known that the overall incidence of identity theft continues to increase. This has led to a certain reticence on the part of many consumers to provide financial information over the Internet or by telephone, impeding their ability to take advantage of the increased convenience provided by various sales channels.

The traditional response to such security concerns has been the development of more secure communications and transaction techniques. Merchants on the one hand respond to information attacks by imposing increased security controls and identity checks;

thieves on the other hand seek to identify flaws in those controls that can be exploited and to develop techniques that can circumvent them. The result is a competitive escalation among merchants and thieves to outdo each other, which each side usually having access to bright, capable minds. From the perspective of some users, the result is an essentially static structure thought to be fraught with risk, a view that is exacerbated when the financial exposure to those users is potentially significant.

There accordingly remains a need in the art for techniques that insulate consumers from attempts by thieves to gain access to their financial information through interception of commercial transactions.

### BRIEF SUMMARY OF THE INVENTION

Rather than focus on improving security for transactions, embodiments of the invention make use of a disposable financial account. The account is disposable in the sense that it is limited in some way or ways, such as by the number of times it may be accessed, being a single-use account in some embodiments. A consumer may fund the account and use it for a transaction, with the account being closed thereafter. This arrangement insulates the consumers' regular financial accounts even in the event of an interception and is effective at limiting the financial exposure of the consumer in transactions that the consumer judges to have an uncomfortable level of risk.

In a first set of embodiments, a method is thus provided of processing a transaction between a consumer and a merchant with a disposable financial account. The disposable financial account is created automatically at a financial institution upon receipt of information provided by the consumer requesting creation of the account through an interface with the financial institution. The consumer is provided with information identifying the disposable financial account through the interface. An authorization request for the transaction is received from the merchant over a financial processing network. The authorization request includes the information identifying the disposable financial account and a transaction amount. An approval for the authorization request is returned to the merchant over the financial processing network based on financial parameters of the disposable financial account. Funds are transferred from the disposable financial account corresponding to the transaction amount to control of the merchant. The disposable financial account is automatically closed after satisfaction of a predetermined condition.

There are a number of different types of conditions that may be satisfied to initiate automatic closure of the disposable financial account. For instance, in one embodiment, satisfaction of the predetermined condition comprises approval of a predetermined number of transactions, which may in some instances be exactly one transaction. In another embodiment, satisfaction of the predetermined condition comprises passage of a predetermined period of time. In a further embodiment, satisfaction of the predetermined condition comprises approval of transactions totaling a predetermined value. In some instances, the predetermined condition may be defined by the consumer.

The interface with the financial institution may comprise an Internet interface in some embodiments. An example of information identifying the disposable financial account includes an account number and perhaps also a personal identification number (“PIN”).

In some instances, the disposable financial account is funded prior to receiving the authorization request for the transaction, in which case the financial parameters of the disposable financial account may comprise a balance of the disposable financial account. For example, the disposable financial account may be funded by transferring an amount defined by the consumer through the interface with the financial institution from a second financial account identified by the consumer through the interface. By way of example, the second financial account could comprise a demand deposit account maintained on behalf of the consumer at the financial institution or could comprise a credit account.

In other instances, it is verified after receiving the authorization request that a second financial account identified by the consumer through the interface with the financial institution is capable of providing at least the transaction amount. Thereafter, at least the transaction amount is transferred from the second financial account to the disposable financial account. Again, examples of the second financial account include a demand deposit account maintained on behalf of the consumer at the financial institution or could comprise a credit account. Automatically creating the disposable financial account could comprise verifying that the second financial account is capable of supporting a specified financial amount.

In some embodiments, a time period may be set after which the disposable financial account is to be automatically closed if the predetermined number of transactions has not been reached. One example of a merchant comprises an Internet merchant, with the transaction between the consumer and the merchant having been arranged through the Internet.

In a second set of embodiments, methods are also provided for processing a transaction between a consumer and a merchant with a disposable financial account. The disposable financial account is maintained at a financial institution on behalf of the consumer. The disposable financial account is funded with funds identified by the consumer. An authorization request for the transaction is received from the merchant over a financial processing network. The authorization request includes information identifying the disposable financial account and a transaction amount. It is verified that the transaction amount is no greater than a balance of the disposable financial account. An approval for the authorization request is returned to the merchant over the financial processing network. Funds are transferred from the disposable financial account corresponding to the transaction amount to the control of the merchant. The disposable financial account is automatically closed after approval of a predetermined number of transactions.

Similar to the first set of embodiments, the predetermined number of transactions may be exactly one in some embodiments. The information identifying the disposable financial account may comprise an account number and perhaps also a PIN. Excess funds remaining in the disposable financial account after transferring funds to control of the merchant may be refunded back to the consumer.

The disposable financial account may be opened at the financial institution after receipt of information provided by the consumer requesting opening of the disposable financial account. For instance, such information requesting opening of the disposable financial account could be received over the Internet. In some embodiments, a time period may be set after which the disposable financial account is to be automatically closed if the predetermined number of transactions has not been reached. In one embodiment, a card is issued to the consumer; in such an embodiment, information identifying the disposable financial account included in the authorization request comprises information extracted from the card. The disposable financial account could be funded by transferring funds into the disposable financial account from a demand deposit account maintained at the financial institution on behalf of the consumer. In an embodiment where the merchant comprises an Internet merchant, the transaction may have been arranged between the consumer and the merchant through the Internet.

In a third set of embodiments, methods are also provided for processing a transaction between a consumer and a merchant with a disposable financial account. A request is received from the consumer through an Internet interface at the financial institution to create the disposable financial account. The request includes an identification of a second financial account and a funding amount. The disposable financial account is opened automatically upon receipt of the request. The funding amount is transferred from the second financial account into the disposable financial account. The consumer is provided with an account number identifying the disposable financial account and a PIN associated with the disposable financial account is established for the consumer. An authorization request for the transaction is received over a financial processing network. The authorization request includes the account number, the PIN, and a transaction amount. It is verified that the transaction amount is no greater than the funding amount. An approval for the authorization request is returned to the merchant over the financial processing network. Funds corresponding to the transaction amount are transferred from the disposable financial account to control of the merchant. The disposable financial account is automatically closed after returning the approval for the authorization request, ensuring that the disposable financial account can be used only exactly once in support of a transaction.

In different ones of such embodiments, a second financial account comprises a demand deposit account maintained at the financial institution on behalf of the consumer or comprises a credit account. If the transaction amount is less than the funding amount, excess funds remaining in the disposable financial account after transferring funds to control of the merchant may be transferred back to the consumer.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of an architecture for consumer transactions in which embodiments of the invention may be implemented;

FIG. 2 provides a schematic illustration of sources that may be used for funding a disposable financial account in embodiments of the invention;

FIG. 3 is a flow diagram that summarizes methods of creating and using a disposable financial account in transactions;

FIG. 4 is a flow diagram that summarizes methods of processing financial transactions using a disposable financial account; and

FIG. 5 is a schematic diagram of a computational device on which methods of the invention may be embodied.

### DETAILED DESCRIPTION OF THE INVENTION

Embodiments of the invention provide a disposable financial account that may be used within a consumer-transaction architecture to support transactions for the purchase of goods and/or services. The disposable account may be funded by any source of funds of a consumer's, with those sources then being insulated from improper discovery during a transaction supported by the disposable account. In different embodiments, the disposable account may be funded before a transaction in a manner similar to the funding of demand deposit accounts (“DDAs”), but in other embodiments, value is associated with the disposable account on a credit basis. Such embodiments may advantageously be simpler for financial institutions to implement in some instances, because the need to execute refunds of value may be avoided, but they may be coupled with the increased risks to the financial institution associated with all credit arrangements. It is generally anticipated that the disposable account will be used without any associated physical device. In some instances, though, a physical device like a card may be issued to a consumer to identify the disposable account.

The disposable account may generally be used in any financial transaction that could traditionally be supported by a consumer account accessible to a merchant. But the risk associated with use of the account is significantly mitigated by the insular nature of the account—even in the event of interception of information regarding the account, a thief would at best gain access to an account whose funds have been consciously earmarked by the consumer. In those instances where the disposable account is a single-use account, the thief would in most instances merely gain access to an account that had already been rendered valueless. Use of the disposable account is thus especially valuable for remote transactions, such as mail-order, Internet, or telephone transactions.

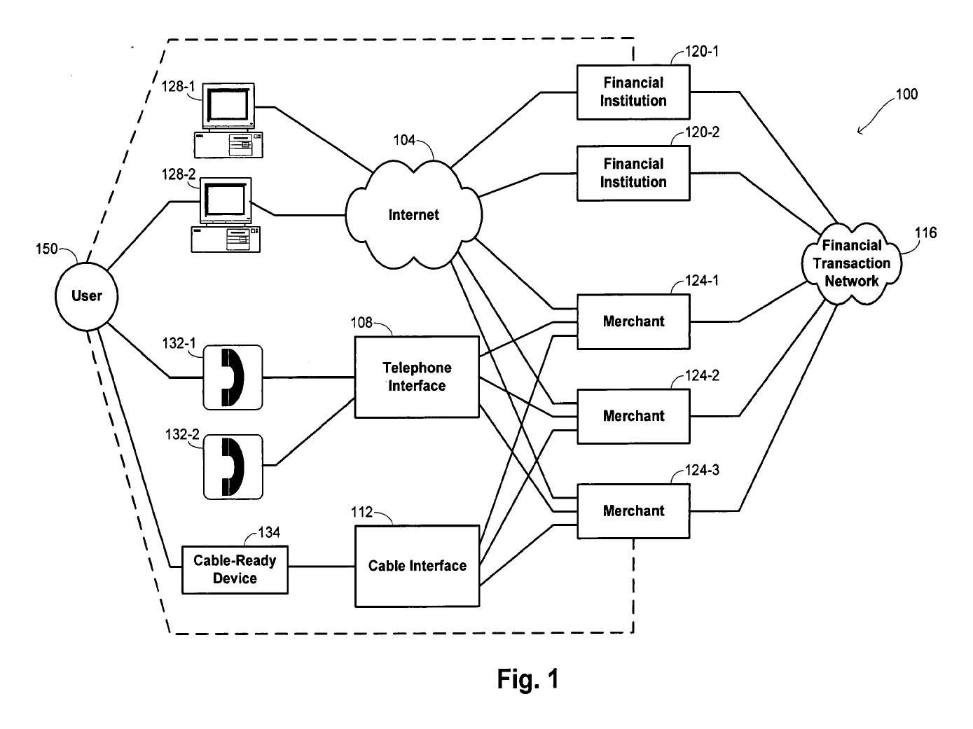

Embodiments of the invention may accordingly be operated within a financial infrastructure like the one shown schematically in FIG. 1. In this illustration, the infrastructure 100 provides a number of different mechanisms by which a user 150 may interact with financial institutions 120 and with merchants 124. These various mechanisms are intended to illustrate that any suitable communications protocol may be used in implementations of the invention, and that the invention itself is not limited to any particular communications protocol. Furthermore, the different communications protocols that may be used may include land-line communications, wired communications, wireless communications, and the like. For example, interactions may be effected with financial institutions 120 through the Internet 104, which is a public network that may implement encryption security protocols. A user 150 typically exchanges information with the Internet using a computational device 128 like a personal computer, laptop, cellular telephone, personal digital assistant (“PDA”), or the like; some of these communications may use wireless protocols while others used wired or land-line protocols. Interactions with merchants 124 may take place through the Internet 104, a telephone interface 108, or a cable interface 112. The telephone interface 108 may sometimes comprise a dual-tone multiple-frequency (“DTMF”) interface that permits a user to transmit information with a touch-tone telephone. In other instances, the telephone interface 108 acts as a mechanism for routing calls from the user 150 through a telephone 132 to a human service agent. Communications are made between the user 150 and the service agent by voice, with the service agent using a local computer to input information. A cable interface 112 connected with a cable-ready device 134 may provide another mechanism for exchanging information between the user 150 and a merchant 124. In such instances, information is exchanged over coaxial or similar cable through a cable network.

While it is generally anticipated that most interactions between the user 150 and a financial institution 120 or merchant 124 will take place using one of these primary interfaces, i.e. the Internet 104, a telephone interface 108, or a cable interface 112, dashed lines in the drawing indicate that other possibilities for interaction also exist. For instance, a user 150 may visit a financial institution 120 personally in certain implementations of the invention, or may send instructions by mail. Similarly, certain consumer transactions may be made in person or by mail with a merchant 124.

Execution of transactions between the merchants 120 and financial institutions 124 generally takes place through a separate financial transaction network 116. Such a network has greater security because it is a private network, as compared with the public-network character of the Internet 104. Transactions between merchants 120 and financial institutions 124 typically include an exchange of an authorization request and a response that confirms the financial institution 124 will make payment. In different embodiments, the disposable account may be of a character that provides a guaranteed transaction similar to traditional transactions made using debit cards or may provide a nonguaranteed transaction similar to traditional transactions made using credit cards. Such a financial transaction network 116 may also be used in executing financial transactions among different financial institutions 120 in implementing embodiments of the invention. This may be useful, for example, in embodiments where a disposable account is created at one financial institution 120-1 using funds held at a different financial institution 120-2 as a source of funds.

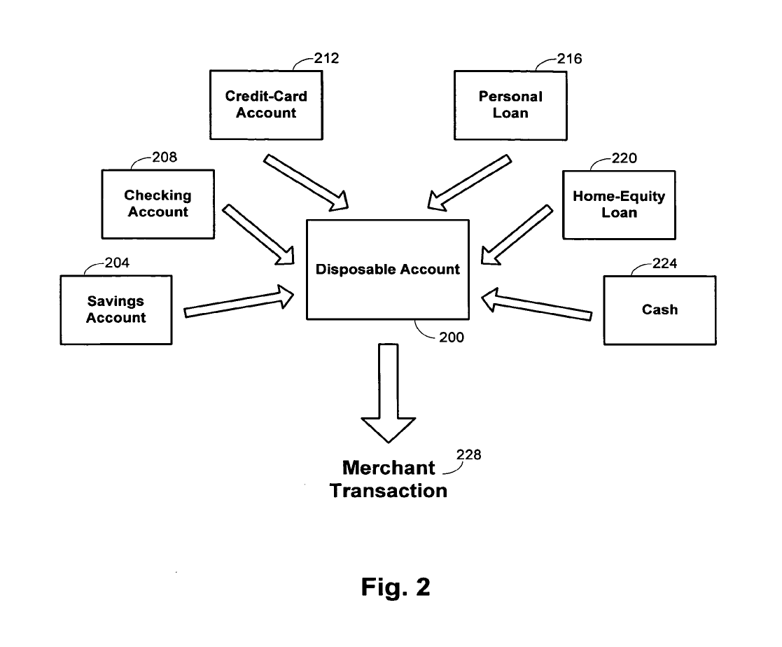

FIG. 2 provides a schematic illustration of the fact that the invention is not limited to any particular source of funds to support the disposable account 200. It is anticipated that a frequent source of funds will be a demand deposit account, like a savings account 204 or checking account 208; a credit-card account 212 is also frequently expected to be a source of funds. But in other embodiments, loan arrangements may be used to provide funding, such as with a personal loan 216, a home-equity loan 220, or the like. These various types of arrangements may advantageously use communications mechanisms like the Internet in identifying the source of funds to the financial institution when establishing the disposable account. This is particularly straightforward when using a savings account 204, checking account 208, or credit-card account 212 as a source of funds. Still other sources of funds may be used, however, such as in embodiments where cash 224 or its equivalent in the form of a negotiated instrument is used. Funding using such mechanisms may sometimes be effected by a personal visit on the part of the user 150 to the financial institution or to a device operated by or on behalf of the financial institution, like an ATM or similar device.

As previously noted, in some embodiments, actual earmarked funds may be deposited within the disposable account. This may be effected in the case of a savings or checking account 204 or 208 by transferring the funds into the account, or by obtaining a cash advance against a credit card in the case of a credit-card account 212. When the funds are provided by another loan arrangement like a personal loan 216 or home-equity loan 220, the deposited funds may be proceeds from the loan. In other embodiments, the account may remain unfunded, but be supported by an identified source of funds that will be accessed after a transaction is approved. Such embodiments may use a risk analysis to evaluate the likelihood that the funds will be available when needed. Irrespective of how the disposable account 200 is funded, it subsequently becomes available for use in a merchant transaction 228.

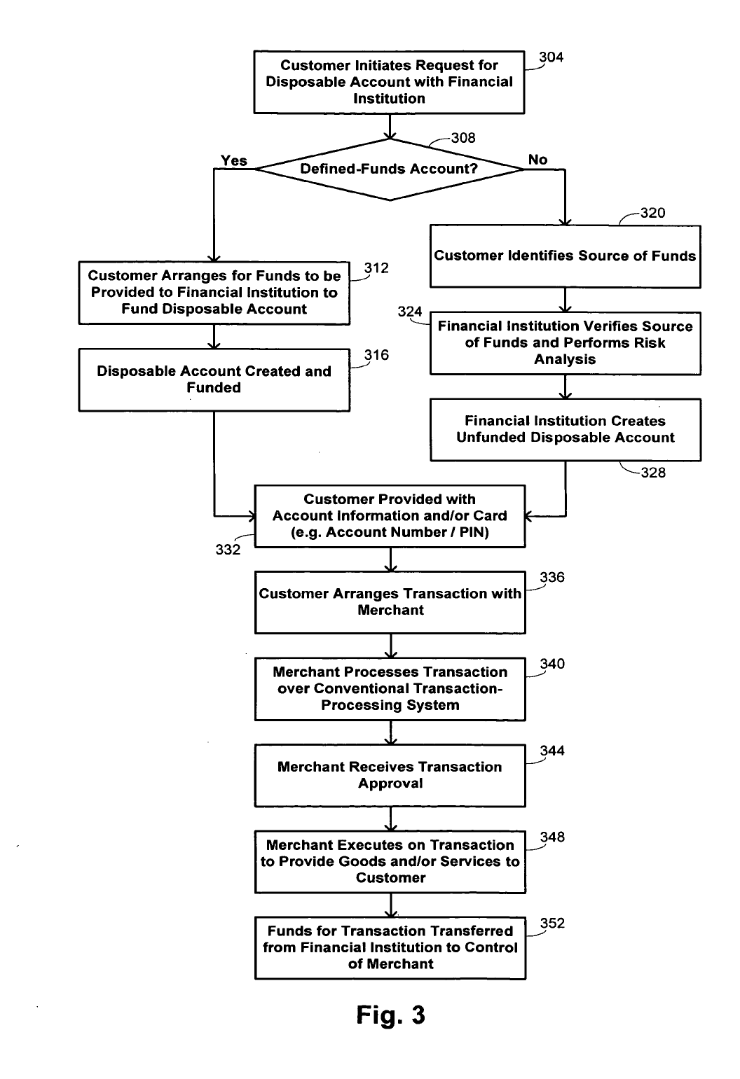

An overview of how the disposable account may be created and used within the infrastructure shown in FIG. 1 is illustrated with the flow diagram of FIG. 3. The methods begin at block 304 with a request for the disposable account being initiated by a consumer with a financial institution 120. Such a request may be made over an electronic interface like the Internet 104 such as by completing an interface provided by the financial institution 120 on a web site, could be made in person by a consumer interacting with a clerk at the financial institution 120, could be made by mail, etc. While there is considerable variety in the manner by which requests may be conveyed to the financial institution 120, there are advantages to use of an electronic interface such as may be provided with the Internet. In particular, such an arrangement permits information to be collected in an automated fashion, avoiding the need for direct interaction between the consumer and staff of the financial institution 120.

The specific information collected in the request may depend in part on the specific structure to be provided to the disposable financial account. In some embodiments, the financial institution 120 may offer only one type of account, say a funded account, and will therefore always require the same type of information in the request. In other instances, the financial institution 120 may offer a number of different types of accounts, with the consumer providing that information identified as needed for the desired account. Thus, for example, an institution may offer a defined-funds account in which funds are to be deposited into the disposable account or may offer an account that remains unfunded. Creation of the account may thus proceed differently as checked at block 308. An automated interface such as used over the Internet may easily accommodate these types of variations, providing different fields to the consumer for completion as the consumer defines desired characteristics of the account.

If the account is to be a defined-funds account, the consumer arranges for funds to be provided to the financial institution 120 to fund the disposable account at block 312. In many instances, the source of funds will be maintained at the same financial institution 120 where the disposable account is to be created so that specification of an account number by the consumer may be all that is needed. In other instances where the disposable account is to be created at one financial institution, say financial institution 120-1, and the source of funds is located at a different financial institution, say financial institution 120-2, the consumer may provide an identification of the source financial institution 120-2 and an account number. This permits financial institution 120-1 to execute a transaction over the financial transaction network 116 to retrieve the funds. This type of transaction may be a debit transaction, such as when the source of funds comprises a DDA account at financial institution 120-2, or may be a credit transaction, such as when the source of funds comprises a cash advance on a credit-card account. Irrespective of how the funds are obtained, the financial institution creates and funds the disposable account at block 316. A service fee may be charged to the consumer as part of creating the disposable account.

If the account is instead to remain unfunded, the consumer may still need to identify a source of funds at block 320. Rather than obtain funds from this identified source at this time, the existence of the source of funds is verified and a risk analysis performed at block 324. Such an analysis seeks to confirm that the risk that the funds will not be available when a future transaction is executed with the disposable account is low, and is thus similar to risk analyses performed in any extension of credit to a consumer. Techniques for performing such a risk analysis are known to those of skill in the art. If the funds source can be verified and the risk analysis provides a favorable result, the financial institution may create an unfunded disposable account at block 328. Even though the account is unfunded, it may still be limited in the size of a transaction that may be approved. The limit associated with the account may depend on the results of the verification and analysis that were performed at block 324. In some cases, expected to be rare, the results of the analysis may permit the disposable account to be unfunded and without any predetermined limit imposed on the size of transactions it may support.

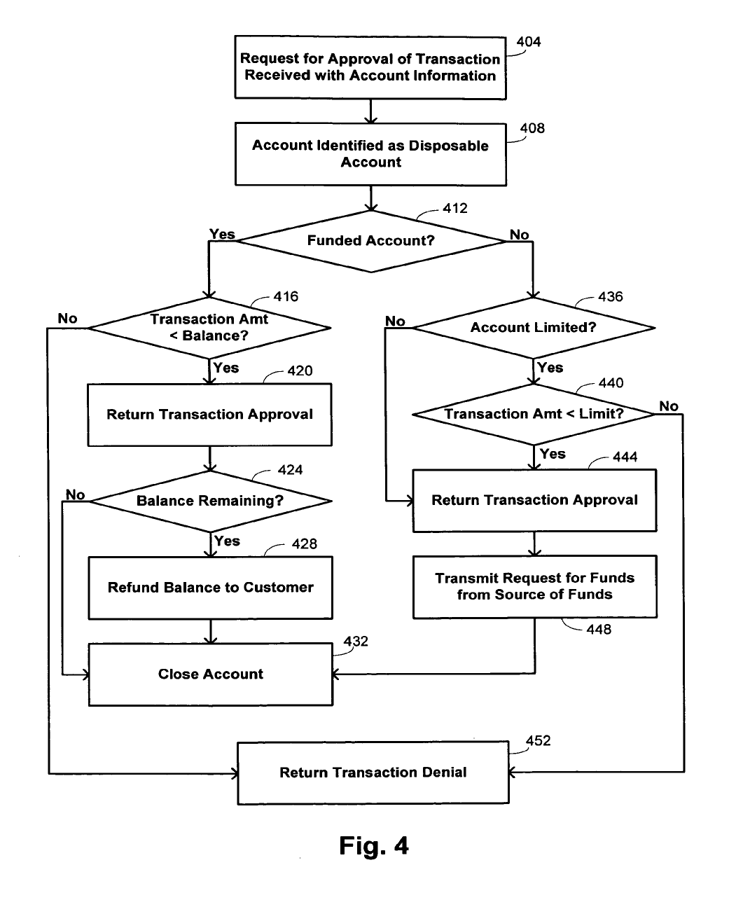

Use of the disposable account by the consumer proceeds in substantially the same fashion irrespective of whether the account was created as a funded account at block 316 or as an unfunded account at block 328. The account is usually assigned an account number so that it may be identified, and information is maintained by the financial institution 120 identifying the consumer who opened the account. In some embodiments, a signature may have additionally been collected from the consumer and maintained in records of the financial institution 120. In many embodiments, the disposable account will also have time constraints requiring that it be used before a specified date and/or time; if unused by that date and/or time, the account will be closed in a manner similar to that described below in connection with FIG. 4. A personal identification number (“PIN”) may be associated with the account. At block 332, the consumer is provided with information regarding the account, such as the account number and PIN, to permit the consumer to use the account in support of a transaction. While not required by the invention, in some instances a card may be issued to the consumer bearing the account number and name of the consumer; this information may be embossed on the card, included on a magnetic stripe, or otherwise encoded. It is anticipated that most transactions executed with the disposable account will be remote transactions requiring only that the consumer provide the account number and perhaps also the PIN, but issuance of a card additionally permits the consumer to execute transactions using the disposable account at brick-and-mortar locations.

A transaction may accordingly be arranged by the consumer with a merchant at block 336. The arrangement may be made using any of the mechanisms described in connection with FIG. 1, including using an Internet web site to request purchase of goods and/or services, using a telephone interface to initiate a transaction, using a cable interface to initiate a transaction, selecting goods by physically visiting a merchant, transmitting a mail-order request, or the like. In arranging the transaction, the consumer provides account information for the disposable account to the merchant, usually including at least the account number and perhaps also the consumer name, the PIN, a signature, etc. The information that is provided to the merchant permits the merchant to process the transaction in a conventional way at block 340 by transmitting an approval request for the transaction over the financial transaction network 116. The approval request includes the information collected from the consumer to identify the financial account as well as a transaction amount.

If the transaction is approved by the financial institution, the merchant receives a transaction approval over the financial transaction network at block 344. Receipt of the approval prompts the merchant to perform on the transaction by providing the goods and/or services to the consumer at block 348. Funds for the transaction are transferred to the control of the merchant from the financial institution at block 352. This transfer is most typically performed as part of a periodic settlement process in which the financial institution makes transfers at the end of a defined period (such as at the end of each day) to give effect to all transactions executed among multiple parties during the period.

Generally, embodiments of the invention embrace use of an account that is disposable in the sense that it is closed automatically upon satisfaction of a predetermined condition or set of conditions. Examples of conditions that may initiate such automatic closure include approving a predetermined number of transactions, which may be exactly one in some instances, having a predetermined period of time pass, approving individual transactions that don't exceed a predetermined value, approving transactions that collectively don't exceed a predetermined value, and the like. In some cases, the predetermined condition may be defined or programmed either statically or dynamically by the consumer. A summary of how transactions using the disposable account may be processed is provided with the flow diagram of FIG. 4. This diagram illustrates methods that may be applied when the disposable account is a single-use account, i.e. when automatic closure of the disposable account is initiated upon approval of a single transaction, but the methods may be readily modified when a different condition applies. The diagram also includes certain checks for types of account characteristics as an illustration of how those checks may be performed in embodiments where an array of different disposable account types are available for consumers. In other embodiments where only a single type of disposable account is provided, or where a smaller number of account types are provided, some of these checks may be omitted, with the method proceeding in accordance with the applicable portions of the flow diagram.

The method begins at block 404 with receipt of a request for approval of a transaction. The request may be received at a financial institution 120 that manages the disposable account, sometimes through an intermediary transaction processor, with the considerations described below being performed by the financial institution 120. In other instances, the different functions may be performed by a combination of an intermediary transaction processor and the financial institution 120 or could even be performed by a transaction processor that acts as a proxy for the financial institution 120. The request received at block 404 generally includes account information that identifies the disposable financial account, such as in the form of an account number, and perhaps including verification information such as a PIN provided by the consumer, a name of the account holder, a signature, or the like. This information is used at block 408 to identify the account and to identify it as being a disposable account limited in having a predetermined number of transactions that may be executed with it. This identification may also determine whether the disposable account is an active account. In instances where the account is created with an expiration date and/or time, this may confirm that the expiration date and/or time have not yet passed. In addition, the transaction request usually includes a total amount for the transaction, and may include more detailed information specifying what products are included in the transaction, the identity of the merchant executing the transaction, and the like.

Subsequent processing may depend on the nature of the account, such as whether it is a funded account or an unfunded account. A check is accordingly made at block 412, with functions on the left side of the page being performed for a funded account and functions on the right side of the page being performed for an unfunded account. For a transaction to be approved when made against a funded account, the disposable account generally must have sufficient funding to cover the transaction. A check is accordingly made at block 416 whether the transaction amount specified in the transaction request is less than the balance of the funded disposable account. If so, the transaction is approved and a transaction approval is returned back to the merchant at block 420 through the communications channels used to receive the initial request. This permits the merchant to proceed with execution of the transaction.

It is generally anticipated that in many instances the disposable account will have been funded with sufficient funds to cover an anticipated transaction, but without being provided with the exact level of funding needed to support the transaction. A check is accordingly made at block 424 whether any funds remain in the account after the transaction has been approved. In embodiments where multiple transactions may be performed, such a check is performed after the predetermined number of transactions has been executed. If a balance is remaining, it may be refunded to the consumer at block 428, usually by effecting a transfer of the remaining funds back to the original source of the funds, although in other embodiments they may be provided to the consumer in a different fashion. In such alternative embodiments, the consumer may have been given an opportunity to specify at the time of creation of the account how excess funds are to be distributed. In addition, while it is generally expected that any service fee imposed on the account will be charged at the time of creation of the account, it is possible for such a fee instead to be imposed at the time excess funds are returned to the consumer at block 428. Certain supplementary service fees may also be imposed at this stage in accordance with policies of the financial institution, such as to account for circumstances where the transaction involves a currency conversion or is executed in a foreign country.

Once any balance has been refunded to the consumer, the account is closed at block 432. Such closure may also take place directly in response to a determination at block 424 that no balance remains in the account after it has been used to support the predetermined number of transactions. Block 452 of the flow diagram indicates that a transaction denial is returned to the merchant in the event that the account initially lacks sufficient funds to support the transaction, as determined at block 416.

In embodiments where the account is an unfunded account, a check may be made at block 436 whether the account has a predetermined limit associated with it. This is expected to be the usual case, and a check is accordingly performed at block 440 whether the transaction amount is less than that limit. A transaction approval is generated at block 444 if the transaction amount is within the limit, or may be generated automatically in those generally rare circumstances where the account has no predetermined limit associated with it. The transaction approval is returned to the merchant along the communications channels over which the approval request was received so that the merchant may proceed with execution of the transaction. Because the account was an unfunded account, a request is also generated at block 448 by the financial institution 120 to request the necessary funds from the funding source identified by the consumer at the time of creation of the account and verified by the financial institution 120. In cases where an unfunded account is used, it may be more common for the service fee to be imposed at the time of executing a transaction rather than during creation of the account. Thus, the request transmitted at block 448 may be for an amount of the transaction augmented by the imposition of any suitable service fees, including a fee for use of the disposable account, and potentially including certain supplementary fees for unusual processing conditions, such as currency conversions, foreign-country transactions, and the like.

Similar to the functions performed with the funded account, the account is closed at block 432 after as many transactions as authorized by the predetermined number of uses associated with the account have been executed. Block 452 again indicates that a transaction denial may be returned to the merchant if the necessary approval conditions for the transaction have not been met, in this instance by a request for a transaction having an amount that exceeds the limit imposed on the disposable account.

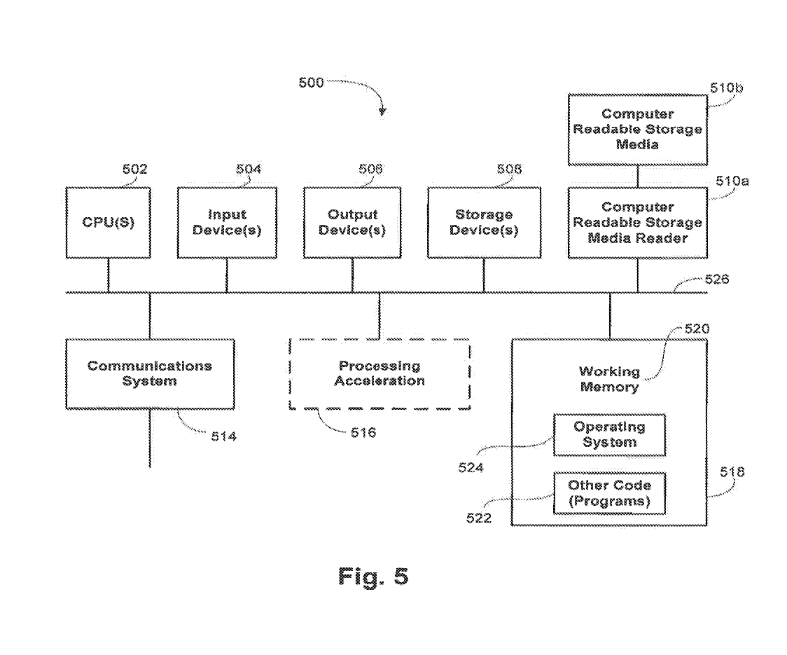

FIG. 5 provides a schematic illustration of a structure that may be used to implement computational devices 500 used by the financial institutions 120 and/or merchants 124 in implementing embodiments of the invention. FIG. 5 broadly illustrates how individual system elements may be implemented in a separated or more integrated manner. The server computational device 500 is shown comprised of hardware elements that are electrically coupled via bus 526, including a processor 502, an input device 504, an output device 506, a storage device 508, a computer-readable storage media reader 510a, a communications system 514, a processing acceleration unit 516 such as a DSP or special-purpose processor, and a memory 518. The computer-readable storage media reader 510a is further connected to a computer-readable storage medium 510b, the combination comprehensively representing remote, local, fixed, and/or removable storage devices plus storage media for temporarily and/or more permanently containing computer-readable information. The communications system 514 may comprise a wired, wireless, modem, and/or other type of interfacing connection and permits data to be exchanged over the architecture described in connection with FIG. 1.

The computational device 500 also comprises software elements, shown as being currently located within working memory 520, including an operating system 524 and other code 522, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1-33. (canceled)

34. A method, comprising:
receiving, via one or more processors, information provided by a consumer requesting creation of an auxiliary account, the information including a source of funds comprising at least one of an account or a loan, identified by the consumer for the auxiliary account, the source of funds being located at a first financial institution;
determining, via the one or more processors, whether to create the auxiliary account based on a risk analysis performed on the source of funds, the risk analysis including verifying availability of funds for at least one future transaction;
based on the determining, creating, via the one or more processors, the auxiliary account at a second financial institution;
sending, via the one or more processors, to the consumer, information identifying the auxiliary account;
detecting, via the one or more processors, a condition for closing the auxiliary account; and
based upon detection of the condition, permanently closing the auxiliary account, via the one or more processors, such that the auxiliary account remains closed thereafter.
